(19) United States
(12) Patent Application Publication
(10) Pub. No.: US 2024/0194199 A1
(43) Pub. Date: Jun. 13, 2024

(54) INFORMATION PROCESSING DEVICE

(71) Applicant: TOYOTA JIDOSHA KABUSHIKI KAISHA, Toyota-shi (JP)

(72) Inventor: Eiichi MAEDA, Asaka-shi (JP)

(73) Assignee: TOYOTA JIDOSHA KABUSHIKI KAISHA, Toyota-shi (JP)

(21) Appl. No.: 18/473,513

(22) Filed: Sep. 25, 2023

(30) Foreign Application Priority Data
Dec. 9, 2022 (JP) 2022-197038

(51) Int. Cl. G10L 15/22; G06F 3/16; G06F 16/61; G06F 16/635

(52) U.S. Cl. CPC G10L 15/22; G06F 3/167; G06F 16/61; G06F 16/635; G10L 2015/223

(57) ABSTRACT

A control unit is provided to execute: acquiring a user's utterance; searching a first sound source capable of providing a first music piece via wireless communication in response to a request for reproducing a first music piece being included in a user's utterance; acquiring information regarding the sound quality of the first music piece for each of the plurality of first sound pieces in response to the plurality of first sound pieces being present; selecting a second sound piece having the highest sound quality among the plurality of first sound pieces; and reproducing a first music piece provided from the second sound piece.

### CROSS-REFERENCE TO RELATED APPLICATION

This application claims priority to Japanese Patent Application No. 2022-197038 filed on Dec. 9, 2022, incorporated herein by reference in its entirety.

### BACKGROUND

### 1. Technical Field

The present disclosure relates to an information processing device.

### 2. Description of Related Art

Determining the bit rate of streaming data to be delivered according to the speed of a vehicle is known (see, for example, Japanese Unexamined Patent Application Publication No. 2021-043350 (JP 2021-043350 A)).

### SUMMARY

An object of the present disclosure is to increase the degree of satisfaction of a user when a musical piece is played.

An aspect of the present disclosure provides an information processing device including a control unit that executes:
acquiring utterance of a user;
searching for, in response to inclusion of a request for playing a first musical piece in the utterance of the user, a first sound source that is able to provide the first musical piece via wireless communication;
acquiring, in response to a plurality of the first sound sources, information on sound quality of the first musical piece for each of the first sound sources;
selecting a second sound source having the highest sound quality among the first sound sources; and
playing the first musical piece provided from the second sound source.

Further, another aspect of the present disclosure is an information processing method in which a computer executes processing of the information processing device, a program for causing a computer to execute the processing, and a storage medium storing the program in a non-transitory manner.

According to the present disclosure, it is possible to increase the degree of satisfaction of the user when the musical piece is played.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment;

FIG. 2 is a block diagram schematically illustrating an example of a configuration of each of an in-vehicle device and a music server that constitute the system according to the embodiment;

FIG. 3 is a diagram illustrating a functional configuration of an in-vehicle device; and

FIG. 4 is a flow chart of a music reproduction process in the in-vehicle device according to the embodiment.

### DETAILED DESCRIPTION OF EMBODIMENTS

A technique of reproducing a music piece stored in a navigation system of a vehicle based on an utterance of a user is known. Here, when a music piece can be acquired from a plurality of content providers, the sound quality of the music piece may be different for each content provider. For example, some content providers provide music at a high bit rate, while others provide music at a low bit rate. Therefore, for example, when a content provider is randomly selected, it may be difficult for a user to reproduce a music piece with satisfactory sound quality. Therefore, the information processing device according to the present disclosure includes a control unit that executes: acquiring a user's utterance; searching a first sound source capable of providing the first music piece via wireless communication in response to the user's utterance including a request to reproduce the first music piece; acquiring information on the sound quality of the first music piece for each of the plurality of first sound pieces in response to the plurality of first sound pieces; selecting a second sound piece having the highest sound quality among the plurality of first sound pieces; and reproducing the first music piece provided from the second sound piece.

The control unit acquires the utterance of the user by, for example, a microphone. The request for playing back the first music piece may be, for example, a request specifying a music piece name, a singer name, a group name, a genre, an album name, a playlist name, or the like. The control unit searches for the first music piece requested by the user from a plurality of sound sources via wireless communication. The sound source is a device capable of providing data of a music piece, and includes a server on the Internet and the like. The server may be, for example, a server managed by a content provider providing a music distribution service. There may be multiple servers. For example, the control unit may determine the sound quality according to the bit rate. That is, the sound source that provides the data of the music with the highest beat rate may be selected as the second sound source.

By acquiring and reproducing data of a musical piece from such a second sound source, it is possible to reproduce a musical piece having a sound quality satisfactory to the user.

Hereinafter, embodiments of the present disclosure will be described with reference to the drawings. The configurations of the following embodiments are illustrative, and the present disclosure is not limited to the configurations of the embodiments.

### First Embodiment

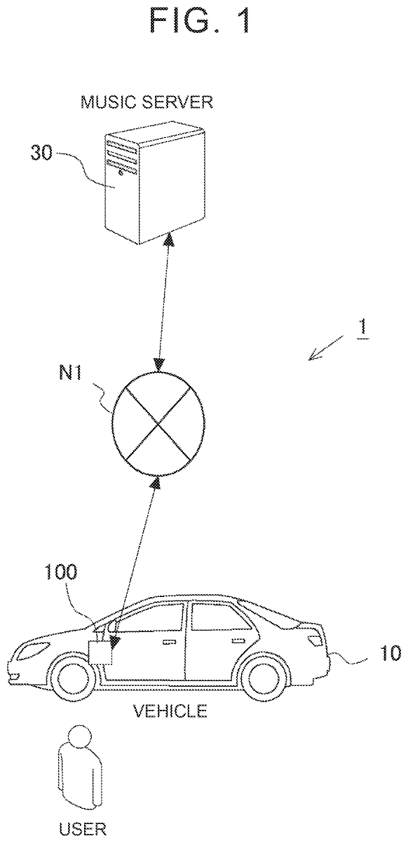

FIG. 1 is a diagram illustrating a schematic configuration example of a system 1 according to an embodiment of the present disclosure. In the example of FIG. 1, the system 1 includes an in-vehicle device 100 mounted on the vehicle 10 and a music server 30. The music server is an example of a first sound source and a second sound source.

The in-vehicle device 100 includes, for example, a navigation system or a multi-information display (MID). The in-vehicle device 100 reproduces the music in response to a request from the user. The in-vehicle device 100 can search for a music piece by, for example, a Web.

The music server 30 is, for example, a server that provides music for a fee or free of charge via the Internet. There may be a plurality of music servers 30. The plurality of music servers 30 are managed by different content providers. The data of the music provided from the music server 30 can be downloaded and stored in the in-vehicle device 100. The in-vehicle device 100 can access one or more music servers 30. The user may perform user registration in advance for the music server 30.

The in-vehicle device 100 searches for and reproduces a music piece when the user requests reproduction of the music piece by utterance. When searching for music, the in-vehicle device 100 searches for a plurality of music servers 30. Then, the data of the music is downloaded from the music server 30 that provides the data with the highest sound quality among the music servers 30 that provide the music for which the request has been made, and is reproduced. Here, although the sound quality may differ depending on the music server 30, it is possible to increase the satisfaction of the user by acquiring and reproducing the music of higher sound quality.

The in-vehicle device 100 and the music servers 30 are connected to each other by a networked N1. Note that the network N1 may be, for example, a global public communication network such as the Internet Wide Area Network (WAN) or another communication network. The network N1 may include a telephone communication network such as a mobile telephone, and a radio communication network such as Wi-Fi. Although one music server 30 is exemplarily shown in FIG. 1, there may be a plurality of music servers 30.

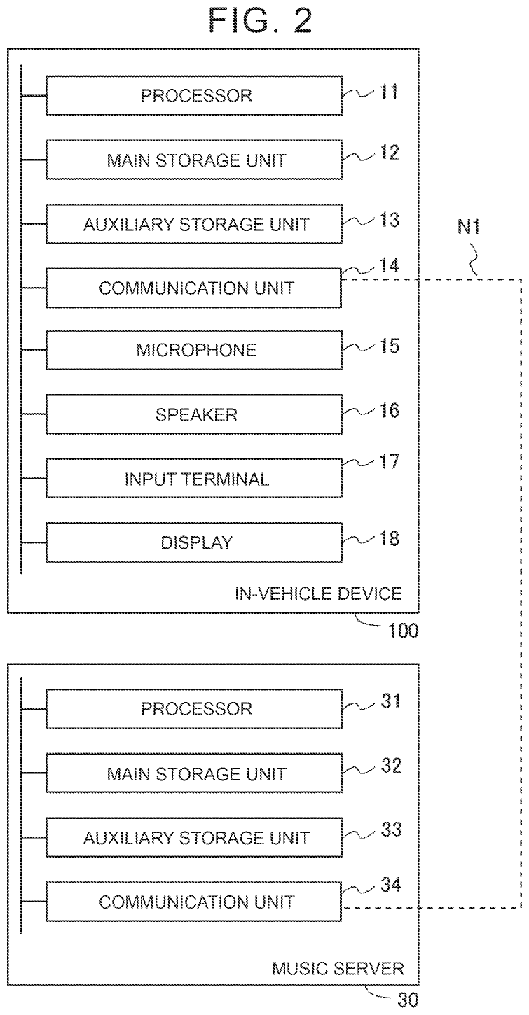

Next, a hardware configuration of the in-vehicle device 100 and the music server 30 will be described with reference to FIG. 2. FIG. 2 is a block diagram schematically showing an example of the configuration of each of the in-vehicle device 100 and the music server 30 constituting the system 1 according to the embodiment.

The in-vehicle device 100 has a configuration of a computer. The in-vehicle device 100 includes a processor 11, a main storage unit 12, an auxiliary storage unit 13, a communication unit 14, a microphone 15, a speaker 16, an input terminal 17, and a display 18. The components are connected to each other by a bus. The processor 11 is an example of a control unit. The main storage unit 12 and the auxiliary storage unit 13 are examples of storage units.

The processor 11 is a Central Processing Unit (CPU), a Digital Signal Processor (DSP), or the like. The processor 11 controls the in-vehicle device 100 to calculate various information processing. The main storage unit 12 is a Random Access Memory (RAM), Read Only Memory (ROM), or the like. The auxiliary storage unit 13 is an Erasable Programmable ROM (EPROM), Hard Disk Drive (HDD), a removable medium, or the like. The auxiliary storage unit 13 stores Operating System (OS), various programs, various tables, and the like. The processor 11 loads the program stored in the auxiliary storage unit 13 into the work area of the main storage unit 12 and executes the program. Through the execution of the program, each component is controlled. As a result, the in-vehicle device 100 realizes a function that matches a predetermined purpose. The main storage unit 12 and the auxiliary storage unit 13 are computer-readable recording media.

The communication unit 14 is a communication unit for connecting the in-vehicle device 100 to a network N1. The communication unit 14 is a circuit for performing communication with another device (for example, the music server 30 or the like) using a radio communication network such as a mobile communication service (for example, 6th Generation (6G), 5th Generation (5G), 4th Generation (4G), 3rd Generation (3G), Long Term Evolution (LTE) or the like, a Wi-Fi (registered trademark), Bluetooth (registered trademark) Low Energy, Near Field Communication (NFC), or Ultra Wideband (UWB)).

The microphone 15 is a device for inputting sound. The sound input to the microphone 15 includes the sound of the user. The speaker 16 is a device that outputs sound. The sound includes music. The input terminal 17 is an interface for connecting an external device. The input terminal 17 includes, for example, a USB terminal and an AUX terminal. The display 18 is a device for presenting information to a user, and includes, for example, a Liquid Crystal Display (LCD) or an Electroluminescence (LE) panel.

The music server 30 has a configuration of a computer. The music server 30 includes a processor 31, a main storage unit 32, an auxiliary storage unit 33, and a communication unit 34 similar to those of the in-vehicle device 100.

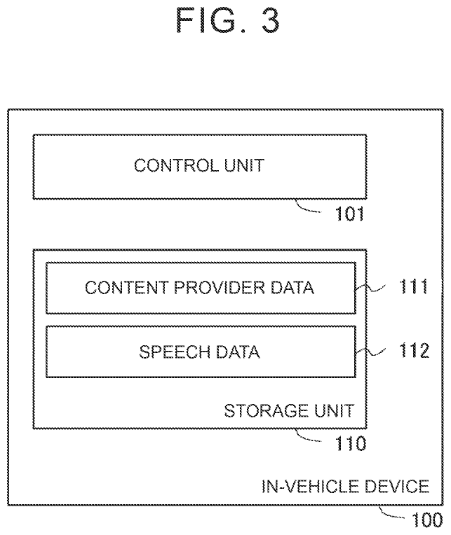

FIG. 3 is a diagram exemplifying a functional configuration of the in-vehicle device 100. The in-vehicle device 100 includes a control unit 101 and a storage unit 110 as functional components. The processor 11 of the in-vehicle device 100 executes processing of the control unit 101 by a computer program in the main storage unit 12.

The storage unit 110 includes a main storage unit 12 and an auxiliary storage unit 13. The storage unit 110 stores content provider data 111 and speech data 112.

The content provider data 111 is data related to a content provider available to a user or a content provider for which user registration has been completed. The content provider data 111 includes information related to the music server 30 and information related to user registration. The information related to the music server 30 includes, for example, information related to Uniform Resource Identifier (URI of the music server 30). The user registration-related information includes, for example, user ID and password-related information required for acquiring the music data from the music server 30. The user ID and the password are inputted to the in-vehicle device 100 by the user.

The control unit 101 receives a request to reproduce a music piece from the user via the microphone 15. The control unit 101 constantly monitors the utterance of the user, and determines that there is a music request when there is a specific utterance. Specific utterances include, for example, “multiply by <1>,” “play <1>.” “play <1>,” and the like. <1> corresponds to, for example, a music name, a singer name, a music genre, an album name, a playlist name, and a combination thereof. The utterance data 112 stores information related to an utterance when the user requests reproduction of a music piece. The control unit 101 compares the utterance of the user with the information stored in the utterance data 112, and determines whether there is a request to reproduce a music piece from the user.

In addition, the control unit 101 specifies the music piece requested by the user. That is, the music corresponding to <1> is specified. Known techniques can be used to identify the music. In addition, a machine learning model in which a user's utterance is input and a music name is output may be used to specify a music piece. Similarly, a singer name, a music genre, an album name, a playlist name, and the like can be identified.

Then, the control unit 101 searches for a music piece requested by the user. At this time, for example, all available music servers 30 are searched, and music servers 30 (first sound sources) capable of providing data of the requested music are extracted. Further, information on the sound quality of the music is acquired for each of the extracted music servers 30. For example, the control unit 101 acquires the bit rate of the data of the music piece as the information on the sound quality. Then, the music server 30 (second sound source) that provides the data of the music with the highest sound quality (that is, the highest bit rate) is extracted. Then, the control unit 101 downloads the data of the music from the extracted music server 30 and stores the data in the auxiliary storage unit 13. Thereafter, the control unit 101 reproduces the data of the music piece stored in the auxiliary storage unit 13. Note that, instead of the bit rate, the sound quality may be determined based on the extension (file format) of the music data. For example, it may be determined that the uncompressed file has a higher sound quality than the compressed file. Further, it may be determined that the lower the compression ratio is, the higher the sound quality is. The relationship between the file format and the sound quality is stored in the auxiliary storage unit 13, for example.

When the data of the music with the highest sound quality can be acquired from the plurality of music servers 30, for example, the music server 30 may be selected in accordance with the priority order, or the music server 30 may be selected randomly. In a case where the music server 30 is selected in accordance with the priority order, for example, the priority order of the default sound source specified by the user may be the highest. Alternatively, for example, the priority of the available sound source may be higher than that of the available sound source for a fee, or the priority may be higher as the frequency of use by the user is higher. In addition, the priority may be determined in alphabetical order. Alternatively, a list of available sound sources may be displayed on the display 18 so that a user can select one of them. This selection may be performed by a touch panel or by voice.

When the music server 30 searches for a music piece, the control unit 101 transmits the music piece information to the music piece server 30, for example. The music information includes information on a music name, a singer name, a music genre, an album name, a playlist name, and the like. The music server 30 searches for a music piece based on the music piece information. When a musical piece is found in the music server 30, information on the sound quality is transmitted to the in-vehicle device 100.

On the other hand, when the music is not found in the music server 30, information indicating that the music is found is transmitted to the in-vehicle device 100. At this time, the information on the recommended music piece or playlist may be transmitted from the music server 30 to the in-vehicle device 100. In a case where the music is not found in all the sound sources, the control unit 101 may notify the speaker 16 of the fact that the music is not found by voice or display it on the display 18. In addition, in a case where the music is not found in all the sound sources, the control unit 101 may reproduce, for example, a recommended music piece or a playlist received from the first searched music piece server 30.

When the user designates a specific sound source in the utterance, the music may be searched only by the specific sound source, and the music may not be searched by other sound sources.

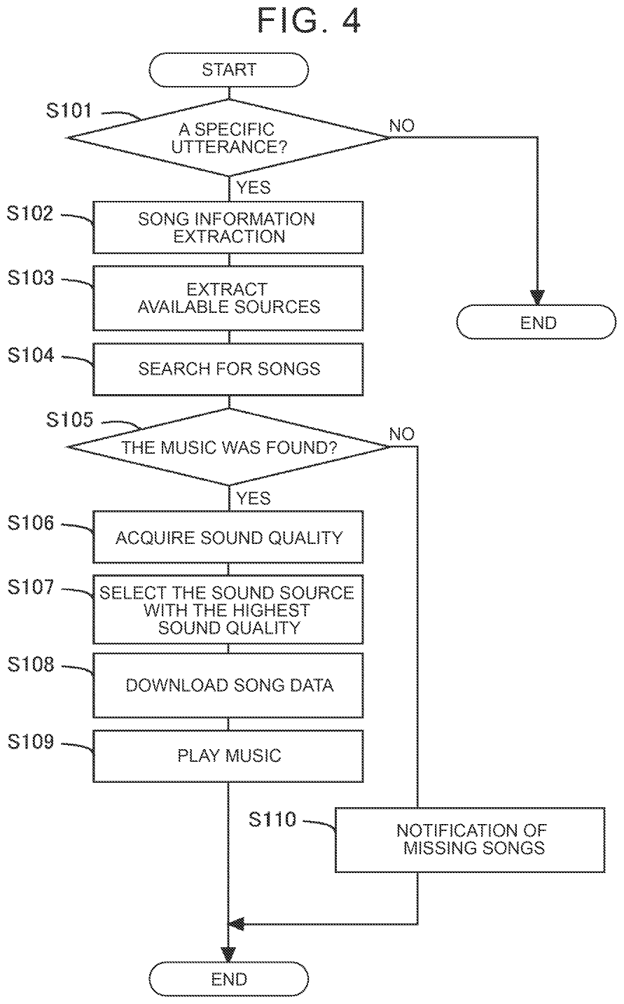

Next, the music reproduction processing in the in-vehicle device 100 will be described. FIG. 4 is a flowchart of music reproduction processing in the in-vehicle device 100 according to the embodiment. The processing illustrated in FIG. 4 is executed at predetermined time intervals in the in-vehicle device 100.

In S101, the control unit 101 determines whether or not a particular utterance has been made. The control unit 101 determines whether or not a specific utterance has been made based on an input from the microphone 15. For this determination, a known speech recognition technique can be used. The control unit 101 determines that a specific utterance has occurred, for example, when an utterance such as “<1> is applied”, “<1> is played back”, or “<1> is played back”. If an affirmative determination is made in S101, the process proceeds to S102, and if a negative determination is made, the routine ends.

In S102, the control unit 101 extracts music data. That is, the control unit 101 extracts the <1> part included in the particular utterance determined in S101. In S103, the control unit 101 extracts a sound source available to the user. At this time, the control unit 101 extracts the music servers 30 that can be connected via the network N1.

In S104, the control unit 101 searches all the sound sources for the music corresponding to the music data. In S105, the control unit 101 determines whether or not a musical piece is found in any sound source. If an affirmative determination is made in S105, the process proceeds to S106, and if a negative determination is made, the process proceeds to S110.

In S106, the control unit 101 acquires information about the sound quality (bit rate) of the respective pieces of music. When the music is retrieved by S104, the sound quality data may be acquired from the music servers 30 and stored in the auxiliary storage unit 13. In S107, the control unit 101 selects the sound source having the highest sound quality. The control unit 101 compares the sound quality of the music pieces provided from the respective sound sources, and selects a sound source that provides the music pieces having the highest sound quality. In S108, the control unit 101 transmits a request for transmitting data of a music piece to the sound source selected in S107, and downloads data of the music piece from the sound source. The control unit 101 stores the downloaded music data in the auxiliary storage unit 13. Then, in S109, the control unit 101 reproduces the music.

On the other hand, if a negative determination is made in S105, the process advances to S110, and the control unit 101 notifies that the music is not found in all the sound sources. For example, the user may be notified of the absence of the music by playing the music through the speaker 16 by voice.

As described above, according to the embodiment, when a musical piece is searched based on a user's utterance, a musical piece is searched from a plurality of sound sources, and therefore, there is a high possibility that a musical piece is found. In addition, since the music with the highest sound quality is reproduced, the user's satisfaction level can be increased.

### OTHER EMBODIMENTS

The above-described embodiments are merely examples, and the present disclosure may be appropriately modified and implemented without departing from the scope thereof. The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function. For example, a part of the functions of the in-vehicle device 100 may be provided in the music server 30.

Further, in the above-described embodiment, an example in which the in-vehicle device 100 reproduces a music piece has been described, but the present disclosure is applicable to, for example, a case in which a mobile terminal (for example, a smartphone) of a user reproduces a music piece in the same manner. Further, in the above-described embodiment, the music is downloaded once and then played back, but instead of this, streaming playback may be performed.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.) and an optical disc (compact disc read-only memory (CD-ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device comprising a control unit that executes:
acquiring utterance of a user;
searching for, in response to inclusion of a request for playing a first musical piece in the utterance of the user, a first sound source that is able to provide the first musical piece via wireless communication;
acquiring, in response to a plurality of the first sound sources, information on sound quality of the first musical piece for each of the first sound sources;
selecting a second sound source having the highest sound quality among the first sound sources; and
playing the first musical piece provided from the second sound source.

2. The information processing device according to claim 1, wherein the control unit determines that the sound quality is high as a bit rate is high.

3. The information processing device according to claim 1, wherein the control unit downloads data of the first musical piece from the second sound source and stores the data in a storage unit.

4. The information processing device according to claim 1, wherein the first sound source is a sound source that provides a musical piece by the wireless communication from an outside of a vehicle.

5. The information processing device according to claim 1, wherein the control unit acquires the utterance of the user via a microphone,
determines whether the request for playing the first musical piece is included based on the utterance of the user and information stored in a storage unit,
transmits a request for searching for the first musical piece for the sound sources in response to inclusion of the request for playing the first musical piece in the utterance of the user,
receives, from the sound sources, a result of search of the first musical piece and the information on the sound quality of the first musical piece,
selects, in response to the first sound sources, the second sound source having the highest sound quality among the first sound sources,
transmits a request for transmitting data of the first musical piece to the second sound source,
stores data of the first musical piece received from the second sound source in the storage unit, and
plays the first musical piece based on the data of the first musical piece stored in the storage unit.
